(19) United States
(12) Patent Application Publication
(10) Pub. No.: US 2020/0268482 A1
(43) Pub. Date: Aug. 27, 2020

(54) Dental Polishing Strip With Threading Tail

(71) Applicant: James Herr, Jefferson, GA (US)

(72) Inventor: James Herr, Jefferson, GA (US)

(21) Appl. No.: 16/797,000

(22) Filed: Feb. 21, 2020

Related U.S. Application Data
(60) Provisional application No. 62/809,787, filed on Feb. 25, 2019.

(51) Int. Cl. A61C 3/06; A61C 15/04

(52) U.S. Cl. CPC A61C 3/06; A61C 15/04

(57) ABSTRACT

A dental polishing tool for use in dental procedures. The polishing tool comprises an elongate polishing strip having an abrading surface. The polishing strip has a leading end and a trailing end. Extending from the leading end of the polishing strip, is a thin, flexible tail which comprises a flexible portion and a rigid tip at the end of the tail. The tail is designed to be inserted into a gap between two adjacent teeth. This tail facilitates positioning of the polishing strip into a position between the teeth. The tail is pulled through to draw the polishing strip into a position between the teeth. The user could then apply the polishing strip against the tooth in a conventional manner.

### TECHNICAL FIELD

This invention relates to dental polishing strips.

### BACKGROUND

When performing a dental restoration, the dentist will often polish the surface to smoothen it. This is typically performed by grinding, sanding, or abrasion techniques. However, polishing the interproximal surface of a restoration presents a particular challenge because of limited access into the interproximal space. But neglecting to smoothen the restoration can cause inflammation and other gingival problems. For instance, when filling resin is placed in the interproximal surface of posterior teeth (such as for treating a cavity), the filling resin can overflow past the margin of the floor of the cavity preparation creating a rough ledge or “overhang.” This overhang can invite periodontal disease because of gingival inflammation or recurring decay. Ideally, there should be a tight, dense contact between the teeth to prevent a food trap.

One common way to remove a resin filling overhang is to sand it down with an abrasive dental polishing strip. The polishing strip is inserted into the interproximal space and polishing is performed by sliding it back-and-forth onto the teeth. Such polishing strips are often made of plastic and this can be a problem with tight interproximal contacts, particularly those in the posterior teeth. The plastic strip has a tendency to crumple or kink in such situations, making it difficult to insert the strip properly. A stainless steel polishing strip is more rigid and can be jammed into a tight contact. However, metal polishing strips do not contour well to the curvature of the tooth and can injure the gum tissue.

Thus, currently available dental polishing strips have deficiencies that make them difficult or inconvenient to use. There is a need for an improved dental polishing strip that can be inserted more easily into tight interproximal contacts.

### SUMMARY

In one aspect, this invention is a dental polishing tool. Elongate Strip: The polishing tool comprises an elongate strip having an abrading surface. The elongate strip may have any suitable length. In some embodiments, the length of the strip is 10 cm or longer; and in some cases, at 13 cm or longer. In some embodiments, the length of the strip is in the range of least 10-22 cm long; and in some cases, in the range of 13-22 cm long.

The elongate strip may have any suitable width. In some embodiments, the width of the strip is 1.8 mm or wider; and in some cases, 2.2 mm or wider. In some embodiments, the width of the strip is in the range of 1.8-7.0 mm; and in some cases, in the range of 2.2-5.5 mm.

The elongate strip may have any suitable thickness. In some embodiments, the thickness of the strip is 0.04 mm or thicker. In some embodiments, the thickness of the strip is 0.3 mm or thinner. In some embodiments, the thickness of the strip is in the range of 0.04-0.2 mm. The elongate strip may have any suitable length-to-width ratio. In some embodiments, the length-to-width ratio is in the range of 30-90. In some embodiments, the leading end of the elongate strip has a tapered shape.

Tail:

The elongate strip has a leading end and a trailing end. Extending from the leading end of the strip, there is a thin, flexible tail that is narrower in width/diameter than the elongate strip. The tail comprises a flexible portion and a rigid tip at the end of the tail. The flexible portion is more flexible than the rigid tip. In some embodiments, the flexible portion of the tail has a different construction or made of a different material than the rigid tip of the tail. In some embodiments, the flexible portion of the tail has a multifilament construction. In some embodiments, the rigid tip has a monofilament construction.

The tail may have any suitable length, as further described below. In some embodiments, the length of the tail is in the range of 5-45 cm, and in some cases, in the range of 10-30 cm long. In some embodiments, the width or diameter of the tail is in the range of 0.5-5.0 mm.

In some embodiments, the trailing end of the elongate strip does not have a tail, i.e. only the leading end of the elongate strip has the tail. The tail and the elongate strip may be made as a single unitary structure, or different structures assembled together. The tail may have any filamentous structure, such as a string, strand, thread, floss, cord, etc. The tail may have any suitable construction, such as monofilament or multifilament construction.

Method of Use:

In another aspect, this invention is a method of using the dental polishing tool. The method comprises inserting the tail into a gap between two adjacent teeth. This could be accomplished by passing the rigid tip through the gap between the two adjacent teeth, or by sliding the flexible portion of the tail between the two adjacent teeth (upwardly for the upper teeth, downwardly for the lower teeth). The tail could be inserted pointing in either direction, that is, with the strip on the exterior side of the teeth or on the interior side of the teeth.

The tail is pulled through to draw the strip into a position between the teeth. The strip is grasped with one hand on one side of the strip towards the leading end. With the other hand, the strip is grasped on the other side towards the trailing end. As used herein, the terms “towards the leading end” and “towards the trailing end” means the lateral sides of the strip on either side of the teeth. One would be on the interior side of the teeth and the other would be on the exterior side of the teeth, depending upon the orientation in which the tail was inserted. The user slides the strip between the teeth in a reciprocating manner.

### BRIEF DESCRIPTION OF THE DRAWINGS

FIGS. 1A and 1B show an example of a dental polishing tool of the invention. FIG. 1A shows a top view and FIG. 1B shows a perspective view.

FIG. 2 shows how the tail of the polishing strip is threaded through a space between two adjacent teeth.

FIG. 3 shows how the tail of the polishing strip is slipped downward between two adjacent teeth.

FIG. 4 shows the polishing strip positioned between the two adjacent teeth.

### DETAILED DESCRIPTION

To assist in understanding the invention, reference is made to the accompanying drawings to shown by way of illustration specific embodiments in which the invention may be practiced. The drawings herein are not necessarily made to scale or actual proportions. For example, lengths and widths of the components may be adjusted to accommodate the page size.

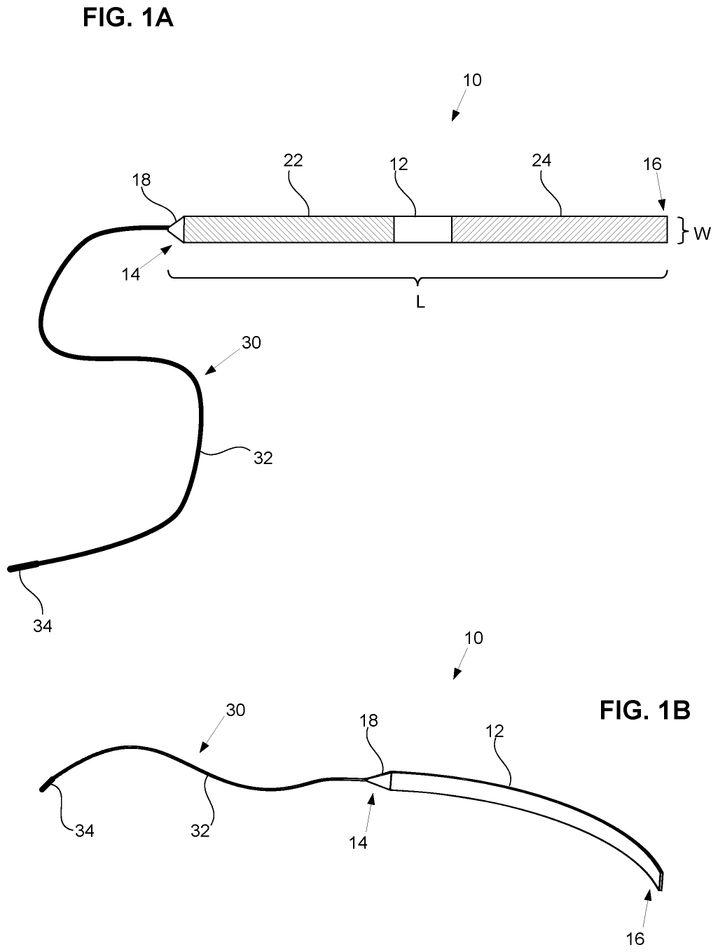

FIGS. 1A and 1B show an example embodiment of the invention. FIG. 1A shows an example dental polishing tool 10 of the invention. FIG. 1B shows a perspective view. The polishing tool 10 comprises an elongate strip 12, which has a leading end 14 and a trailing end 16. The polishing strip 12 could be made of any suitable flexible material, including any of a variety of plastic or metal materials.

The polishing strip 12 has one or more abrading surfaces. The polishing strip 12 could have any of various types of abrading surfaces. Examples of different types of abrading surfaces include “coarse” grit for coarse sanding, “medium” grit for finishing, and “fine” grit for polishing. The elongate strip 12 could have multiple different types of abrading surfaces in different combinations and different configurations. Examples of different configurations are shown in U.S. Patent Application Publication No. 2009/0220912.

In this particular example, elongate strip 12 has two different types of abrading surfaces. Abrading surface 22 is a rougher grade sanding surface whereas abrading surface 24 is a finer grade polishing surface. (The two different types of abrading surfaces are omitted in the perspective view of FIG. 1B to avoid overcluttering the drawing.) There is a gap between the two abrading surfaces 22 and 24. FIG. 1A also shows the dimensions of the polishing strip 12. Its length is measured along the longitudinal axis as indicated by the line “L”; and the width is measured along the transverse axis as indicated by the line “W.” In the example shown here, the width is about 3.5 mm and the length is about 16 cm. The length/width ratio is about 46.

The leading end 14 of the polishing strip 12 has a tapered point 18 to facilitate insertion between teeth. A tail 30 is attached to tapered point 18. The tail 30 may be made of any suitable material and have any suitable construction. In some embodiments, the tail 30 is at least one-half the length of the polishing strip 12; in some cases, at least the same length; and in some cases, at least one and one-half times (150%) the length of the polishing strip 12. The tail 30 has a flexible portion 32 and a rigid tip 34. As used herein, the terms “flexible” and “rigid” with respect to the tail 30 are not intended to designate absolute physical qualities, but instead have relative meaning useful for distinguishing one from the other.

In this example, the flexible portion 32 has a multifilament construction in a manner similar to that of dental floss. The flexible portion 32 of the tail 30 could be made of any suitable natural or synthetic fiber, including polytetrafluoroethylene (PTFE), cotton, silk, nylon, or polyester. The rigid tip 34 could be made of any suitable material and have any suitable construction to increase the rigidity of the tail 30 at its tip. In this example, the rigid tip 34 is made of monofilament construction. Examples of materials that could be used to make rigid tip 34 include nylon and polypropylene.

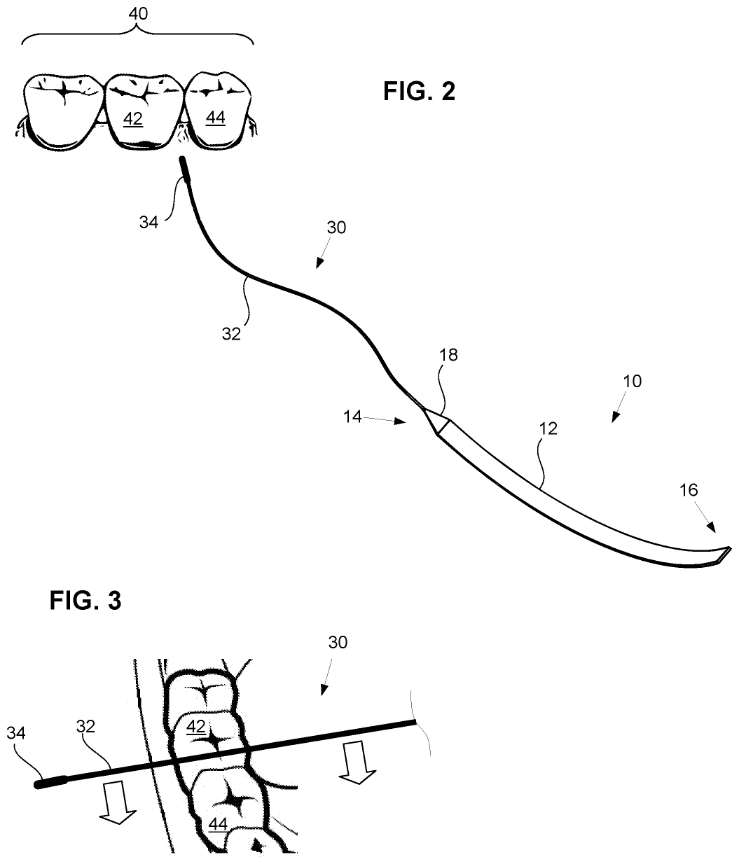

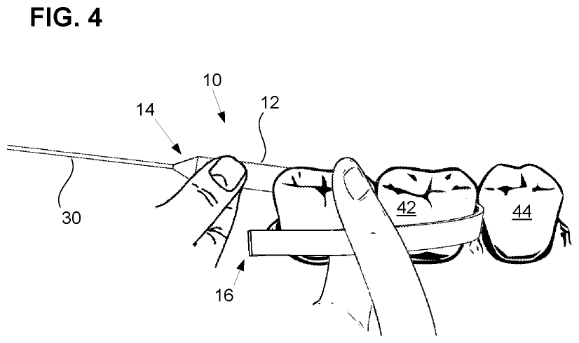

FIGS. 2-4 demonstrate how the polishing tool 10 could be used. FIG. 2 shows a set of molar teeth 40 in a patient. The rigid tip 34 of the tail 30 is threaded through the gap between teeth 42 and 44 beneath the contact faces of teeth 42 and 44 (interproximal space) with the abrading surface facing towards tooth 42. Pulling on tail 30, the polishing strip 10 is drawn into the interproximal space. Alternatively, as shown in FIG. 3, instead of threading the rigid tip 34, the tail 30 may be set between teeth 42 and 44 by making tail 30 taut and sliding the flexible portion 32 down between teeth 42 and 44 (slipped or “slotted” into place in a manner similar to when using dental floss). As shown in FIG. 4, the fingers of one hand grasps a part of the polishing strip 12 towards the leading end 14 and the fingers of the other hand grasps a part of the polishing strip 12 towards the trailing end 16. The polishing strip 12 is then slid back-and-forth in the interproximal space against tooth 42 in a reciprocating movement.

The polishing tool of this invention could be used on any set of teeth in the mouth, but it may be particularly useful for the molar or premolar teeth, where the interproximal space is often very tight. The polishing tool of this invention could be used for any applicable dental procedure, such as interproximal reduction, cosmetic work, or dental restorations (such as fillings, caps, crowns, and onlays).

The foregoing description and examples have been set forth merely to illustrate the invention and are not intended to be limiting. Each of the disclosed aspects and embodiments of the invention may be considered individually or in combination with other aspects, embodiments, and variations of the invention. In addition, unless otherwise specified, the steps of the methods of the invention are not confined to any particular order of performance. Modifications of the disclosed embodiments incorporating the spirit and substance of the invention may occur to persons skilled in the art, and such modifications are within the scope of the invention.

Any use of the word “or” herein is intended to be inclusive and is equivalent to the expression “and/or,” unless the context clearly dictates otherwise. As such, for example, the expression “A or B” means A, or B, or both A and B. Similarly, for example, the expression “A, B, or C” means A, or B, or C, or any combination thereof.

1. A dental polishing tool, comprising:
an elongate strip having an abrading surface, a leading end, and a trailing end;
at the leading end of the elongate strip, a tail having a length of at least one-half the length of the elongate strip;
wherein the tail comprises a flexible portion and a rigid tip at the end of the tail, wherein the flexible portion is more flexible than the rigid tip.

2. The dental polishing tool of claim 1, wherein the tail is at least the same length as the elongate strip.

3. The dental polishing tool of claim 1, wherein the leading end of the elongate strip has a tapered shape.

4. The dental polishing tool of claim 1, wherein the flexible portion of the tail has a multifilament construction.

5. The dental polishing tool of claim 1, wherein the rigid tip has a monofilament construction.

6. The dental polishing tool of claim 1, wherein the flexible portion of the tail has a different construction or made of a different material than the rigid tip of the tail.

7. The dental polishing tool of claim 1, wherein the length of the tail is in the range of 5-45 cm.

8. The dental polishing tool of claim 1, wherein the width or diameter of the tail is in the range of 0.5-5.0 mm.

9. The dental polishing tool of claim 1, wherein the tail is at least the same length as the elongate strip.

10. The dental polishing tool of claim 1, wherein the length of the elongate strip is 13 cm or longer.

11. The dental polishing tool of claim 1, wherein the width of the elongate strip is in the range of 1.8-7.0 mm.

12. The dental polishing tool of claim 1, wherein the thickness of the elongate strip is in the range of 0.04-0.2 mm.

13. The dental polishing tool of claim 1, wherein the elongate strip has a length-to-width ratio in the range of 30-90.

14. A method of performing a dental procedure, comprising:
using a dental polishing strip of claim 1;
inserting the tail into a gap between two adjacent teeth;
pulling on the tail to draw the elongate strip into a position between the teeth;
grasping the elongate strip with one hand on one side of the strip towards the leading end;
grasping the elongate strip with the other hand on the other side of the strip towards the trailing end;
sliding the elongate strip between the teeth in a reciprocating manner.

15. The method of claim 14, wherein the two adjacent teeth are each independently a molar or premolar tooth.

16. The method of claim 14, wherein the step of inserting the tail is performed by passing the rigid tip through the gap.

17. The method of claim 14, wherein the step of inserting the tail is performed by sliding the flexible portion of the tail between two adjacent teeth.

18. The method of claim 14, wherein the leading end of the elongate strip has a tapered shape that facilitates drawing of the elongate strip between the teeth.

19. The method of claim 14, wherein the tail is inserted between the teeth with the elongate strip on the exterior side of the teeth.

20. The method of claim 14, wherein the tail is inserted between the teeth with the elongate strip on the interior side of the teeth.
